(19) United States
(12) Patent Application Publication
(10) Pub. No.: US 2011/0063232 A1
(43) Pub. Date: Mar. 17, 2011

(54) PROJECTIVE-CAPACITIVE TOUCH PANEL AND FABRICATION METHOD THEREOF

(75) Inventors: Chi-Chen Li, Kaohsiung City (TW); Fu-Cheng Huang, Kaohsiung City (TW); Shin-Ming Chen, Kaohsiung City (TW); Shih-Min Wu, Kaohsiung City (TW)

(73) Assignee: ARIMA DISPLAY CORPORATION, Kaohsiung City (TW)

(21) Appl. No.: 12/559,624

(22) Filed: Sep. 15, 2009

(51) Int. Cl. G06F 3/041; H01G 13/00

(52) U.S. Cl. 345/173; 216/6

(57) ABSTRACT

A fabrication method of a projective-capacitive touch panel is provided. The method includes steps of: providing a substrate; forming a metal trace layer on the substrate with a first exposing/developing process and a etching/stripping process sequentially; forming a first pattern layer on the metal trace layer with a second exposing/developing process, a first filming process and a first stripping process sequentially; forming a insulation layer on the first pattern layer; and forming a second pattern layer on the insulation layer with a third exposing/developing process, a second filming process and a second stripping process sequentially.

### FIELD OF THE INVENTION

The present invention relates to a touch panel and a fabrication method thereof, and more particularly to a projective-capacitive touch panel and a fabrication method thereof.

### BACKGROUND OF THE INVENTION

A projective-capacitive touch panel is implemented based on a traditional capacitive touch panel and further includes two sets of transparent wires (X and Y) implemented on two different planes and perpendicular to each other and a plurality of driving wires.

Please refer to FIG. 1, which is a schematic diagram showing a traditional projective-capacitive touch panel according to the prior art. In FIG. 1, the projective-capacitive touch panel 1 includes sequentially a glass substrate 11 as a substrate, an X pattern layer 12 as a first pattern layer, an X pattern protection layer 13 as a first protection layer, a metal trace layer 14, a metal trace protection layer 15 as a second protection layer, a Y pattern layer 16 as a second pattern layer, and a top-coating layer 17 as an insulation layer.

Please refer to FIG. 2, which is a flow chart schematically showing the fabrication method for the traditional projective-capacitive touch panel of FIG. 1 according to the prior art.

(Step 21) A glass substrate 11 as a substrate is provided.

(Step 22) An ITO (Indium Tin Oxide) layer is formed on the glass substrate 11. A coating process, an exposing process, a developing process, an etching process, and a stripping process are sequentially proceeded with some sort of photo-resist (A) on the ITO layer so as to form the X pattern layer 12 as the first pattern layer. Specifically, a first photo mask is used in the step.

(Step 23) A coating process, an exposing process, a developing process, an etching process, and a stripping process are sequentially proceeded with some sort of photo-resist (B) on the X pattern layer 12 so as to form the X pattern protection layer 13 as the first protection layer. Specifically, a second photo mask is used in the step.

(Step 24) A metal layer is sputtered on the X pattern protection layer 13. A coating process, an exposing process, a developing process, an etching process, and a stripping process are sequentially proceeded with some sort of photo-resist (B) on the X pattern protection layer 13 so as to form the metal trace layer 14. Specifically, a third photo mask is used in the step.

(Step 25) A coating process, an exposing process, a developing process, an etching process, and a stripping process are sequentially proceeded with some sort of photo-resist (B) on the metal trace layer 14 so as to form the metal trace protection layer 15 as the second protection layer. Specifically, a fourth photo mask is used in the step.

(Step 26) An ITO layer is formed on the metal trace protection layer 15. A coating process, an exposing process, a developing process, an etching process, and a stripping process are sequentially proceeded with some sort of photo-resist (A) on the ITO layer so as to form the Y pattern layer 16 as the second pattern layer. Specifically, a fifth photo mask is used in the step.

(Step 27) An APR (Asahiksei Photosensitive Resin) is printed and then solidified with UV light on the Y pattern layer 16 into the top-coating layer 17 as the insulation layer.

(Following step) The above half-finished projective-capacitive touch panel is electrically detected and then cut into a finished projective-capacitive touch panel 1.

The above fabrication method for the traditional projective-capacitive touch panel has the following drawbacks:

(1) The total fabrication process has five photo mask procedure and one APR procedure, which complicate the fabrication method. Besides, the fabrication equipments tend to be fully loaded since the coating process, the exposing process, the developing process, the etching process, and the stripping process are repeatedly proceeded.

(2) The environment is polluted for the increase of the acid wash procedures.

(3) To prevent the two pattern layers and the metal trace layer from being eroded by the acid solution, it is necessary to implement another protection layer therebetween. Since being slight acidic, the additional protection layer will have an unfavorable effect on the reliability of the trace. Moreover, the additional protection layer will also decrease the penetrability of the panel for light.

### SUMMARY OF THE INVENTION

It is therefore an object of the present invention to provide a projective-capacitive touch panel and a fabrication method thereof for simplifying the fabrication process, decreasing the cost and improving the performance of the products.

According to the foregoing object of the present invention, a fabrication method of a projective-capacitive touch panel is provided. The method includes steps of: providing a substrate; forming a metal trace layer on the substrate with a first exposing/developing process and a etching/stripping process sequentially; forming a first pattern layer on the metal trace layer with a second exposing/developing process, a first filming process and a first stripping process sequentially; forming a insulation layer on the first pattern layer; and forming a second pattern layer on the insulation layer with a third exposing/developing process, a second filming process and a second stripping process sequentially.

According to the foregoing object of the present invention, a projective-capacitive touch panel is also provided. The projective-capacitive touch panel includes: a substrate; a metal layer on the substrate; a first pattern layer on the metal layer; a top-coating layer on the first pattern layer; and a second pattern layer on the top-coating layer.

By the above projective-capacitive touch panel and a fabrication method thereof, the fabrication process can be shortened, the quantity of the photo mask can be decreased, and the fabrication cost can be lowered. The environment pollution will also be prevented while the penetrability of the panel for light will be increased.

The foregoing and other features and advantages of the present invention will be more clearly understood through the following descriptions with reference to the drawings, wherein:

### BRIEF DESCRIPTION OF THE DRAWINGS

FIG. 1 is a schematic diagram showing a traditional projective-capacitive touch panel according to the prior art;

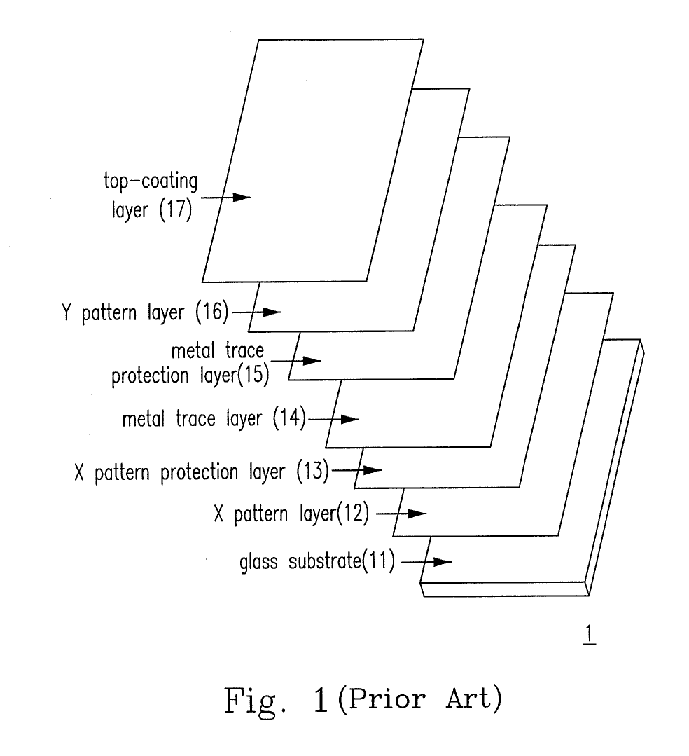

FIG. 2 is a flow chart schematically showing the fabrication method for the traditional projective-capacitive touch panel of FIG. 1 according to the prior art;

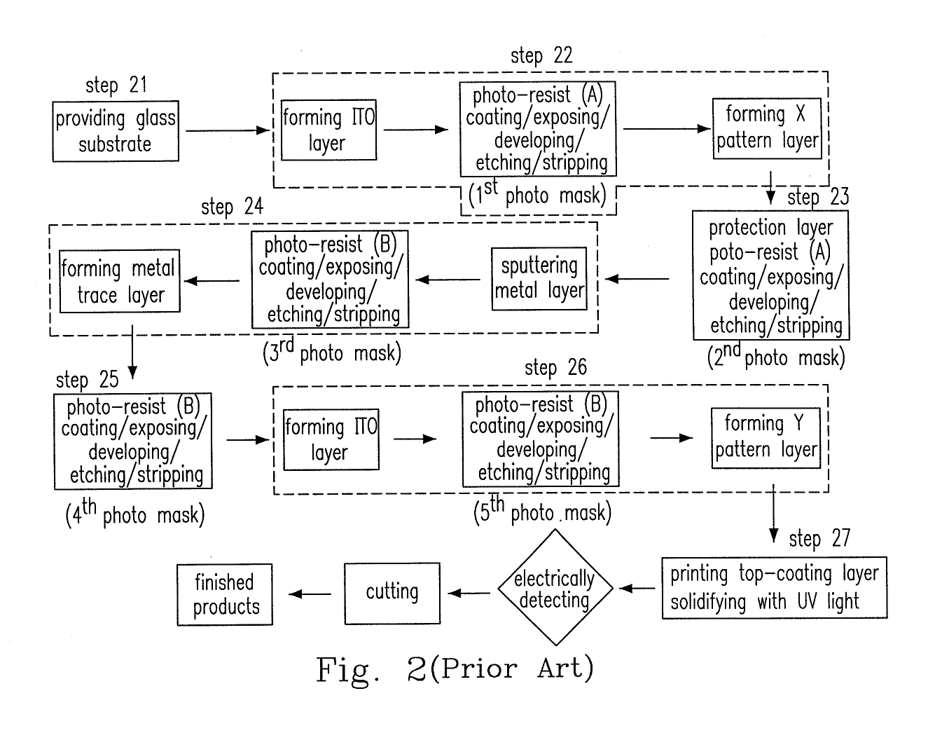

FIG. 3 is a flow chart schematically showing the fabrication method for the projective-capacitive touch panel according to the present invention;

FIG. 4 is a schematic diagram showing the structure of the projective-capacitive touch panel fabricated with the fabrication method of FIG. 3 according to the present invention;

FIG. 5(a) is a schematic diagram showing a lateral view of the structure of the projective-capacitive touch panel of FIG. 4 according to the present invention; and

FIG. 5(b) is a schematic diagram showing another lateral view of the structure of the projective-capacitive touch panel of FIG. 4 according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

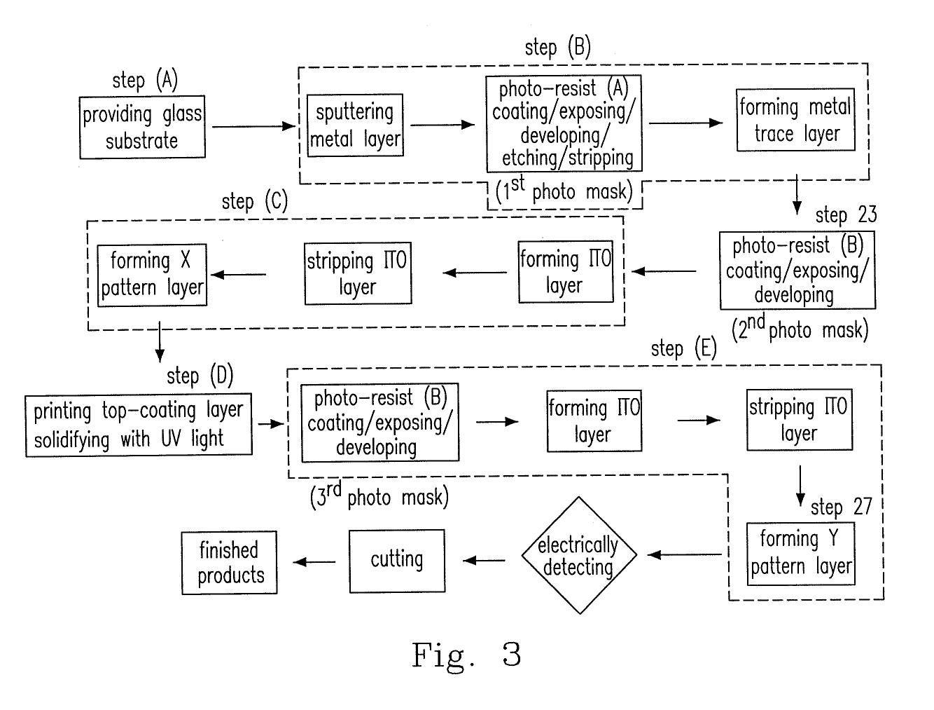

Please refer to FIG. 3, which is a flow chart schematically showing the fabrication method for the projective-capacitive touch panel according to the present invention. The fabrication method for the projective-capacitive touch panel is described as follows.

(Step A) A glass substrate as a substrate is provided.

(Step B) A metal trace layer is formed on the substrate with a first exposing/developing process and an etching/stripping process sequentially. In this step, a metal layer is sputtered on the glass substrate, some sort of photo-resist (A) is coated on the metal layer, and then the first exposing/developing process and the etching/stripping process are sequentially implemented on the metal layer so as to form the metal trace layer. Specifically, a first photo mask is used in the step.

(Step C) A first pattern layer is formed on the metal trace layer with a second exposing/developing process, a first filming process and a first stripping process sequentially. In this step, some sort of photo-resist (B) is coated on the metal trace layer, the second exposing/developing process is implemented on the photo-resist layer, a first ITO layer is formed with the first filming process, and then the first stripping process is implemented on the first ITO layer so as to form an X pattern layer as the first pattern layer.

(Step D) An APR (Asahiksei Photosensitive Resin) is printed and then solidified with UV light on the X pattern layer into the top-coating layer as the insulation layer.

(Step E) A second pattern layer is formed on the top-coating layer with a third exposing/developing process, a second filming process and a second stripping process sequentially. In this step, some sort of photo-resist (B) is coated on the top-coating layer, the third exposing/developing process is implemented on the photo-resist layer, a second ITO layer is formed with the second filming process, and then the second stripping process is implemented on the second ITO layer so as to form an Y pattern layer as the second pattern layer.

(Following step) The above half-finished projective-capacitive touch panel is electrically detected and then cut into a finished projective-capacitive touch pane.

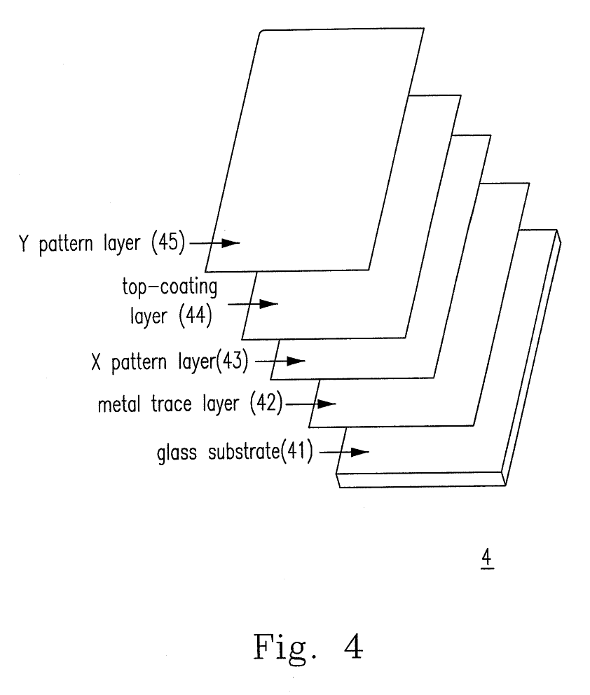

Please refer to FIG. 4, which is a schematic diagram showing the structure of the projective-capacitive touch panel fabricated with the fabrication method of FIG. 3 according to the present invention. In FIG. 4, the projective-capacitive touch panel 4 includes a glass substrate 41 as a substrate, a metal trace layer 42, an X pattern layer 43 as a first pattern layer, a top-coating layer 44 as an insulation layer, and a Y pattern layer 45 as a second pattern layer.

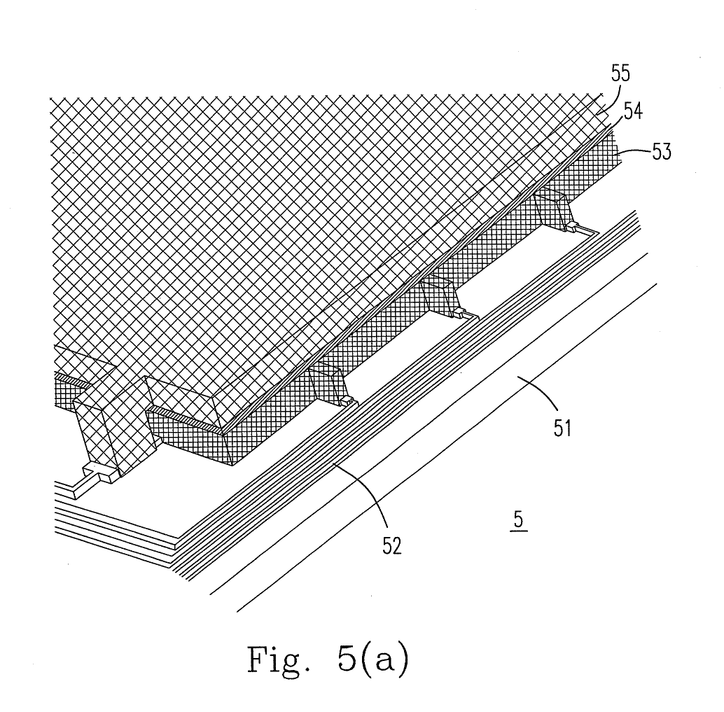

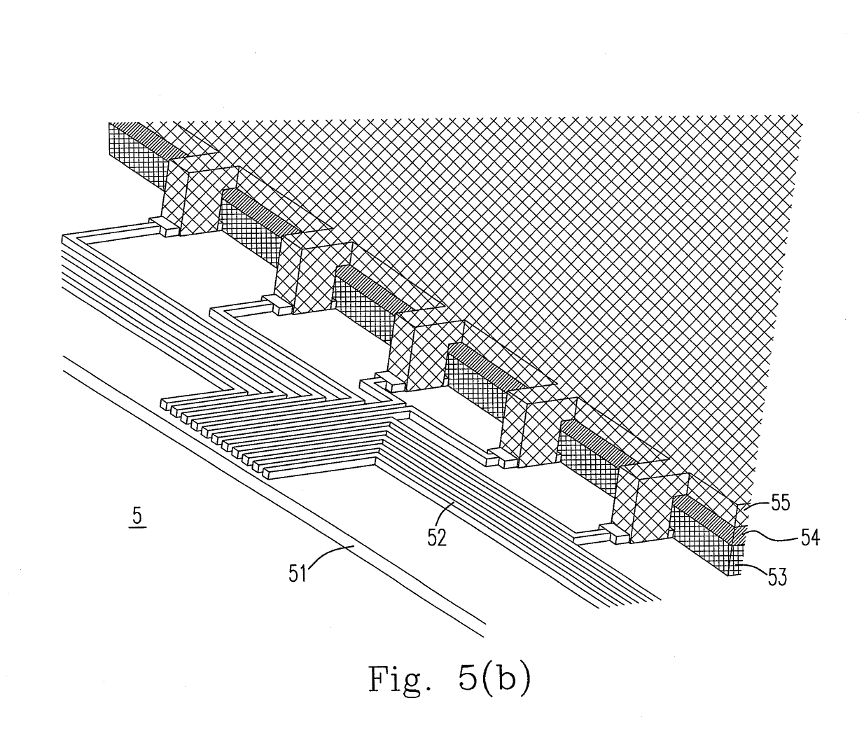

Please refer to FIG. 5(a), which is a schematic diagram showing a lateral view of the structure of the projective-capacitive touch panel of FIG. 4 according to the present invention. As FIG. 5(a) shows, the projective-capacitive touch panel 5 includes a glass substrate 51, metal traces 52, an X pattern layer 53, a top-coating layer 54, and a Y pattern layer 55. Besides, please refer to FIG. 5(b), which is a schematic diagram showing another lateral view of the structure of the projective-capacitive touch panel of FIG. 4 according to the present invention. As FIG. 5(b) shows, it is also clear that the projective-capacitive touch panel 5 includes the glass substrate 51, metal traces 52, the X pattern layer 53, the top-coating layer 54, and the Y pattern layer 55.

In sum, the projective-capacitive touch panel and a fabrication method thereof provided in the present invention can effectively decrease the quantity of the photo mask used in the fabrication process from five to three, which simplifies the fabrication process and decreases the cost. Moreover, the environment pollution will also be prevented while the penetrability of the panel for light will be increased.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A fabrication method of a projected-capacitive touch panel, comprising the steps of:
(A) providing a substrate;
(B) forming a metal trace layer on the substrate by a first exposing and developing process and an etching and stripping process sequentially;
(C) forming a first pattern layer on the metal trace layer by a second exposing and developing process, a first coating process and a first stripping process sequentially;
(D) forming an insulation layer on the first pattern layer; and
(E) forming a second pattern layer on the insulation layer by a third exposing and developing process, a second coating process and a second stripping process sequentially.

2. The fabricating method as claimed in claim 1, wherein the step (B) further comprises the steps of:
(B1) sputtering a metal layer on the substrate; and
(B2) coating a first photoresist layer on the metal layer and transforming the metal layer into the metal trace layer by the first exposing and developing process and the etching and stripping process sequentially.

3. The fabricating method as claimed in claim 1, wherein the step (C) further comprises the steps of:
(C1) coating a second photoresist layer on the metal trace layer and implementing the second exposing and developing process on the second photo-resist layer;
(C2) forming a first Indium Tin Oxide (ITO) layer by the first coating process; and
(C3) transforming the first ITO layer into the first pattern layer by the first stripping process.

4. The fabricating method as claimed in claim 1, wherein the step (D) further comprises the steps of:
(D1) forming an asahiksei photosensitive resin (APR) layer on the first pattern layer; and
(D2) solidifying and transforming the APR layer into the insulation layer with an ultraviolet light.

5. The fabricating method as claimed in claim 1, wherein the step (E) further comprises the steps of:
(E1) coating a third photoresist layer on the insulation layer and implementing the third exposing and developing process on the third photoresist layer;
(E2) forming a second ITO layer by the second coating process; and
(E3) transforming the second ITO layer into the second pattern layer by the second stripping process.

6. The fabricating method as claimed in claim 1 further comprising the steps of:
(F) electrically detecting the projective-capacitive touch panel; and
(G) cutting the projective-capacitive touch panel.

7. A projected-capacitive touch panel, comprising:
a substrate;
a conductive layer disposed on the substrate;
a first pattern layer disposed on the conductive layer;
a coating layer disposed on the first pattern layer; and
a second pattern layer on the coating layer.

8. The projected-capacitive touch panel as claimed in claim 7, wherein the substrate has a material of a glass.

9. The projected-capacitive touch panel as claimed in claim 7, wherein the first pattern layer has a material of an ITO.

10. The projected-capacitive touch panel as claimed in claim 7, wherein the top-coating layer has a material of an APR.

11. The projected-capacitive touch panel as claimed in claim 7, wherein the second pattern layer has a material of an ITO.

12. The projected-capacitive touch panel as claimed in claim 7, wherein the coating layer is a top-coating layer.

13. The projected-capacitive touch panel as claimed in claim 7, wherein the conductive layer is a metal layer.

14. A fabricating method of a touch panel, comprising the steps of:
(A) providing a substrate;
(B) forming a conductive trace layer on the substrate;
(C) forming a first pattern layer on the conductive trace layer;
(D) forming an insulation layer on the first pattern layer; and
(E) forming a second pattern layer on the insulation layer.

15. The fabricating method according as claimed in claim 14, wherein the touch panel is a projected-capacitive touch panel.

16. The fabricating method according as claimed in claim 14, wherein the step (B) is processed by a first exposing and developing process and an etching and stripping process.

17. The fabricating method according as claimed in claim 14, wherein the step (C) is processed by a second exposing and developing process, a first coating process and a first stripping process.

18. The fabricating method according as claimed in claim 14, wherein the step (E) is processed by a third exposing and developing process, a second coating process and a second stripping process.

19. The fabricating method according as claimed in claim 14, wherein the conductive trace layer is a metal trace layer.
